(19) United States
(12) Patent Application Publication
(10) Pub. No.: US 2012/0130793 A1
(43) Pub. Date: May 24, 2012

(54) Method and System for Discounted Offer and Sale of Goods and Services

(76) Inventor: Oron Greenbaum, Givatayim (IL)

(21) Appl. No.: 13/297,917

(22) Filed: Nov. 16, 2011

Related U.S. Application Data
(60) Provisional application No. 61/416,843, filed on Nov. 24, 2010.

(51) Int. Cl. G06Q 30/02

(52) U.S. Cl. 705/14.26

(57) ABSTRACT

A method of discount retailing wherein a link is embedded in a host web page to a transaction for presenting an offer of a service or product sold by a vendor. In response to a purchaser expressing interest by selecting the link, the purchaser is redirected to a landing page that relates to the transaction and is maintained by a discount and clearing service provider website. In response to confirmation of interest by the purchaser, the discount and clearing service provider website conveys a voucher to the purchaser, who presents the voucher to the vendor and receives the selected service or product at a partially discounted price with proof of purchase. The purchaser presents the proof of purchase to the discount and clearing service provider and receives a balance of the discount.

### CROSS-REFERENCE TO RELATED APPLICATIONS

This application claims priority to provisional application No. 61/416,843, filed Nov. 24, 2010, for Method and System for Discounted Offer and Sale of Goods and Services.

### STATEMENT RE: FEDERALLY SPONSORED RESEARCH/DEVELOPMENT

Not Applicable

### BACKGROUND

This invention relates generally to the discounted offer and sale of goods and services, and more specifically to a system and methods for offering goods and services of others at a discount on a network such as the Internet. In another aspect, the invention relates to mechanism for offering a conditional discount in respect of a product or service that is purchased on a network or off-line. In another aspect, it relates to closing the redemption loop particularly in local i.e. off-line commerce.

Methods and systems for offering conditional discounts are known in the art. For example, US 20100287103 to Mason discloses a system and methods to mutually satisfy a consumer with a discount and a vendor with a minimum number of sales by establishing a tipping point associated with an offer for a good or service. If the tipping point is met, the sale of the good or service is executed and the consumer is charged and receives an indication of the discounted sale, such as a certificate. If the tipping point is not met, the discount offer is abandoned and the consumer is not charged.

Such an approach provides a mechanism that ensures a minimum quantity of discounted sales is achieved, thus guaranteeing a threshold income to the vendor before the discount is honored.

On-line vending is generally performed by a host web page including a link to a product or service offered by a vendor, the vendor being required to pay the owner of the host web page for each click by a surfer, which causes the host web page to redirect to the vendor site, regardless of whether in fact the purchase is completed. This means that statistically each sale must subsidize a much larger number of “enquiries”, which cost the vendor but deliver no income in return. Such schemes are commonly known as pay per lead or pay per click.

An alternative scheme also known in the online world is pay-per-sale (PPS), which allows an online vendor to pay for an ad only after the client completed the purchase. This way, the vendor only pays for those ads that bear fruit. PPS technology tracks from when a surfer clicks an on-line ad, until he completes the purchase at an on-line store and thus establishes from which URL the purchaser was directed to the on-line store. It would clearly be of benefit to extend this option also to off-line stores, but doing so gives rises to two problems. One is to track the purchaser from the moment he clicks an advertisement to the moment he completes the purchase. Current approaches to doing this offer the purchaser a discount on presenting a coupon to the vendor. This encourages the purchaser to disclose the advertising source to the vendor and provides valuable feedback to the vendor as to where his ad placements are most profitable. But while the ad agency is able to track that the surfer printed the on-line coupon, it has no way to track that he completed the purchase.

This leads to a further problem relating to what is known in the art as closing the redemption loop particularly in local i.e. off-line commerce. The “redemption loop” refers to the mechanism whereby an agent that serves as the catalyst for a sale is rewarded by the vendor for effecting the introduction. This obviously requires two things: first that the vendor makes an actual sale, and second that the vendor is able to determine unequivocally and reliably that the sale results from an introduction for which an identifiable agent served as the catalyst. So far as commerce that is carried out completely on-line is concerned, it may be possible to close the redemption loop by tracing the chain of URLs that were invoked in order to effect the sale. For example, where an advertising agency is responsible for advertising a vendor's product and, to this end, embeds a URL to the vendor's website on search engines such as Google. Yahoo! and the like, the vendor may be able to detect that a customer who arrives at his website was redirected by clicking on an advertisement placed on Google by the agent.

The high commercial value in closing the redemption loop has been recognized and various approaches have been proposed for doing it. For example, Erick Schonfeld writes in TechCrunch on Jul. 24, 2011 that “When it comes to local commerce, the ultimate prize everyone is going after right now is how to close the redemption loop. The redemption loop starts when a consumer sees an ad or an offer for a local merchant, and is completed when the consumer makes a purchase and that purchase can be tracked back to the offer. If you know who is actually redeeming offers and how much they are spending, you can be much smarter about tweaking and targeting those offers.” He then notes that “In order to complete the circle and track offers all the way through redemptions, it is necessary to either tap into the payment system or create an alternative way to track redemptions” and adds that almost all approaches rely on a shift from emailed coupons to offers delivered through mobile apps.

However, when commercial transactions are carried out off-line, it is much more difficult to close the redemption loop since even where a customer was made aware of an offer for sale through the Internet in response to an ad placed by an ad agency, there is no clear mechanism for tracking this when the customer walks into a high street store to make a purchase.

It would therefore be preferable to provide an alternative mechanism that is amenable to on-line hosting but avoids any costs to the vendor unless the purchase is completed. This in turn allows the vendor to offer lower costs realized by higher discounts, which is of benefit to the purchaser while potentially increased sales and lower overheads are of benefit to the vendor.

### BRIEF SUMMARY

The present invention provides a mechanism for offering a different kind of conditional discount whereby immediately on purchase of a product or service, either at an on-line store or at off-line stored, a partial discount is provided and proof of purchase is then used to obtain the balance of the promised discount. Furthermore, the method according to the invention succeeds in closing the redemption loop regarding on-line oilers and off-line purchases.

According to one aspect of the invention there is provided a computer-implemented method of discount retailing a service or product offered by a vendor on-line via a communications network in a host web page in which there is embedded a link to a transaction offering purchase of said service or product, said method comprising:
(a) in response to a purchaser selecting the link, redirecting the purchaser to a landing page relating to said transaction maintained by a discount and clearing service provider website;
(b) using the landing page to confirm interest in the selected service or product;
(c) in response to confirmation of interest by the purchaser, conveying from the discount and clearing service provider website a voucher to the purchaser entitling the purchaser to a partial discount that is provided by the vendor upon actual purchase together with the selected service or product and proof of purchase to the purchaser; and
(d) upon the purchaser presenting the proof of purchase to the discount and clearing service provider, paying a balance of the discount to the purchaser.

The balance of the discount is paid by the discount and clearing service provider optionally only after first receiving payment from the vendor. However, by the time the vendor is required to pay the discount and clearing service provider, the sale has been completed and the vendor will have already received payment from the purchaser for the complete amount less the partial discount. The vendor is able to earn interest on the initial payment prior to payment of the balance to the discount and clearing service provider, thus at least partially offsetting any commission paid to the discount and clearing service provider.

In accordance with another embodiment, respective links to different transactions are embedded in a host page for selection by an end-user. Typically, the links are selected by the discount and clearing service provider or possibly by the publisher of the host page based on a profile of the end-user. In some embodiments, the links are ranked according to specified criteria that may, for example, be configured to maximize revenue for the discount and clearing service provider.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a pictorial representation of a system according to an embodiment of the invention;

FIG. 2 is a flow diagram showing a method according to an embodiment of the invention for providing discounted goods and services; and

FIG. 3 is a block diagram showing the functionality of a web server operated by a discount and clearing service provider according to the invention.

### DETAILED DESCRIPTION

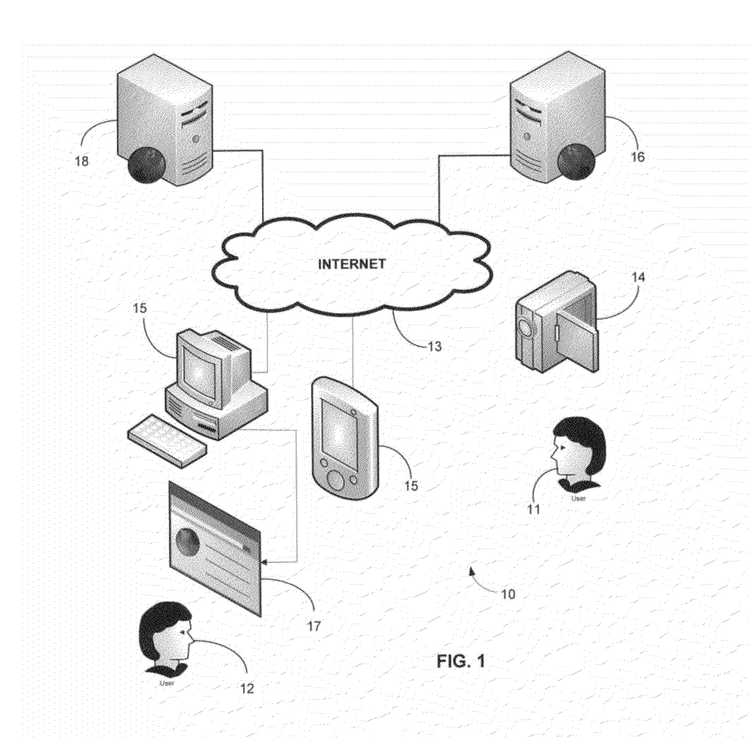

FIG. 1 is a pictorial representation of a system 10 showing the relationship between a vendor 11 and the various intermediaries that are responsible for conveying an offer for sale to an end-user 12 over the Internet 13. Thus, it is assumed that the vendor 11 wishes to offer for sale a camera 14 so that it appears at an end-user's computer 15 either in an ad banner or as a floating ad containing a link for allowing the end-user to order the displayed item. The end-user's computer 15 may, of course, be a hand-held device such as a PDA or mobile telephone having web-browsing capability. The vendor, who might be the manufacturer or distributor of the camera 14, enlists a discount and clearing service provider operating a web server 16. The vendor may be an off-line store which the purchaser must physically visit, or it can be an on-line store that requires no physical contact with the purchaser. The discount and clearing service provider creates an HTML offer-for-sale form using information received from the vendor, which it stores on the web server 16. A link to the HTML offer-for-sale form is conveyed to one or more hosts for embedding into respective host web pages 17 that are hosted on a host web server 18. The hosts may be search engines such as Google, Yahoo!, content providers such as CNN or they may be any web page provider or affiliate that operates on behalf of or in conjunction with the discount and clearing service provider.

Typically, the links that are embedded in the host pages 17 are selected by the discount and clearing service provider or possibly by the publisher of the host pace 17 based on a profile of end-user. To this end, profiles may be set up by or on behalf of end-users or his acquaintance, or may be based on previous transactions that end-users completed, from the end-user ratings of those transactions, questionnaires or surveys, demographic profile, likes and dislikes, price range an end-user is willing to spend, previous deals they enjoyed or did not enjoy, etc. For example, end users may log on to the discount and clearing service provider website and supply relevant information for allowing suitable user profiles to be compiled and maintained. The discount and clearing service provider may then maintain a database of end-users to assist in conveying the most relevant transactions to the host web page so as to increase the chance of an offer for sale being accepted.

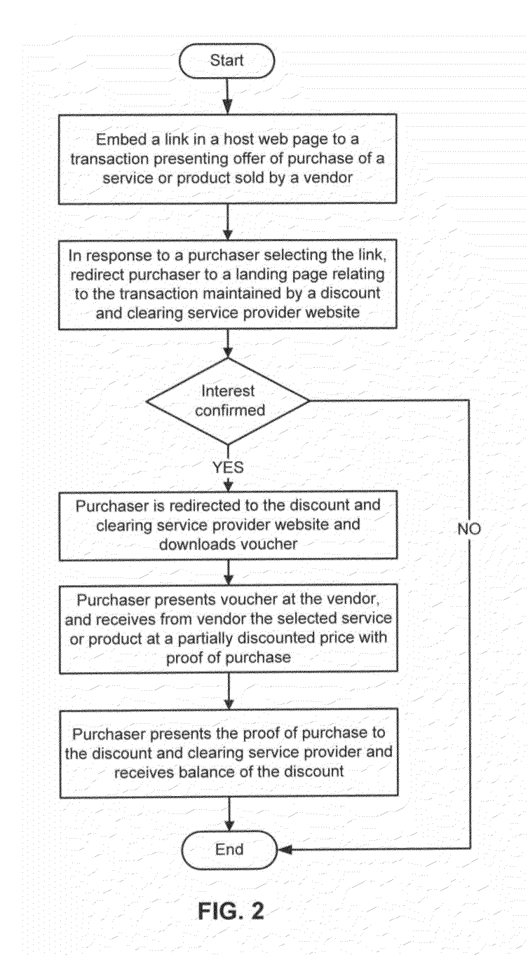

FIG. 2 is a flowchart showing a method of discount retailing carried out by the web server 16 operated by or in conjunction with a discount and clearing service provider. A link is embedded in a host web page to a transaction for allowing purchase of a service or product offered by a vendor. In response to a purchaser selecting the link, the purchaser is redirected to a landing page relating to the transaction maintained by the discount and clearing service provider website and typically stored in the web server 16. The landing page is used by the purchaser to confirm interest in possible purchase of the selected service or product, in response to which, a voucher is conveyed from the discount and clearing service provider website to the purchaser. The purchaser presents the voucher at the vendor, and receives the purchased service or product at a partially discounted price with proof of purchase. The purchaser presents the proof of purchase to the discount and clearing service provider and receives a balance of the discount offered by the vendor. When the method according to the invention is used to close the redemption loop between an on-line offer and an off-line store, the voucher may be printed by the purchaser prior to visiting the off-line store. Alternatively, the voucher may be conveyed electronically to a computer for forwarding or otherwise conveying to mobile device of the purchaser. Conveniently, this may be done by sending the voucher in an e-mail to the purchaser since this may then be accessed by any computer to which the purchaser has access. Upon arrival at the off-line store, the voucher may then be used by the vendor to access the relevant web page at the discount and clearing service provider website. This can be done in many ways. One way is to present the voucher as a QR (Quick Response) code, which is a known type of two-dimensional barcode that encodes the appropriate URL of the discount and clearing service provider website and may be scanned by the vendor and facilitate redirection to the required URL.

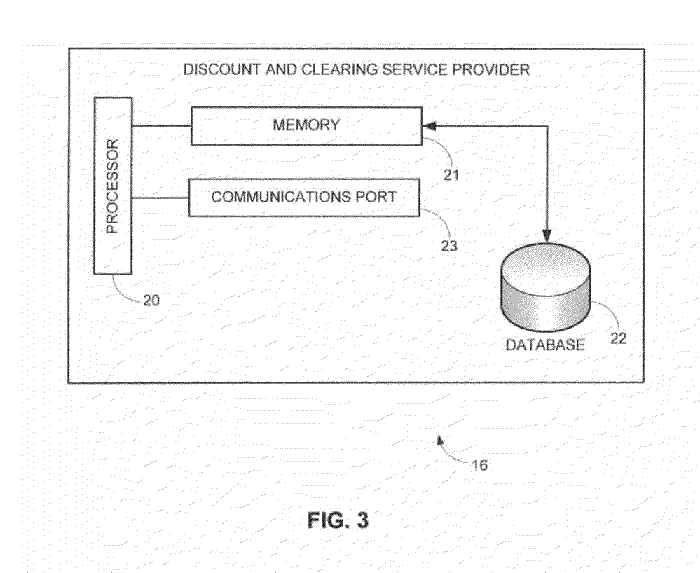

FIG. 3 shows a detail of the web server 16, which includes a processor 20 coupled to a memory 21 which stores software and is coupled to a database 22 that stores transaction data, such as HTML, web pages, vendor account data, ordering data and so on. A communications port 23 is connected to the processor 20 for coupling to the Internet so as to all bi-directional data transfer.

Although the invention has been described with particular reference to an Internet system, the principles of the invention are also applicable for other media. For example, the purchaser may respond to a TV, radio or printed advertisement giving details of the vendor and the discount and clearing service provider. Upon purchase of the goods or services and obtaining partial discount, the purchaser present the proof of purchase to the discount and clearing service provider and, in due course, receives the balance of the discount.

In accordance with some embodiments, upon receiving proof of purchase from the purchaser, the discount and clearing service provider submits a request to the vendor to receive the balance of the discount; and on receipt of the balance from the vendor forwards the balance to the purchaser.

In accordance with other embodiments, the vendor may provide the discount and clearing service provider with proof of sale relating to a transaction underwritten by the discount and clearing service provider. For example, software at the point-of-sale may automatically process a voucher and upon receiving payment from the purchaser may convey proof of purchase automatically to the discount and clearing service provider or may log the transaction for subsequent reporting to the discount and clearing service provider. In the latter case, periodic reports may be sent by the vendor to the discount and clearing service provider relating to all discounted sales in a charging period. It should be noted that in practice commission may be paid by the vendor to the discount and clearing service provider in addition to the balance of the discount payable to the purchaser. The manner in which the commission is actually transferred depends on the prior arrangement between the vendor and the discount and clearing service provider. Typically, an arrangement is reached whereby the vendor decides on the total effective discount he is willing to bear in respect of a transaction and the actual discount that is announced in the offer for sale is reduced by the amount of the commission payable to the discount and clearing service provider. In either case, the invention allows the purchaser to receive the complete discount that appears in the offer for sale.

It should further be noted that payment by the discount and clearing service provider to the host web page service provider may be made from the commission received from the vendor. For example, in the case that the offer for sale appeared on a host web page of a search engine, upon purchase of the product or service and receiving the balance of the discount plus the commission) from the vendor, the discount and clearing service provider may use (the commission to pay the search engine provider. The discount and clearing service provider thus functions not merely as an agent for guaranteeing payment of the balance of the discount to the purchaser, but also serves as a central clearing house that monitors whether all participants in the transaction receive their proper dues.

Regardless of how the offer for sale is communicated to the purchaser, the proof of purchase may be presented by the purchaser to the discount and clearing service provider on-line or in person or by any other means of communication such as fax, SMS, e-mail and so on.

In accordance with some embodiments, the balance of the discount is redeemable within a predetermined time period only.

In accordance with some embodiments, the discount and clearing service provider maintains an account in respect of each purchaser allowing the purchaser to register the purchase and to provide proof of payment and receipt of the cash back. The database may also store relevant information associated with the purchaser, to assist the discount and clearing service provider in making direct payment after receiving payment from the vendor. In such an embodiment, the discount and clearing service provider may optionally compile periodic statements for each vendor for charging each vendor a respective cumulative balance on all discounted sales prior to payment by the discount and clearing service provider to each respective purchaser of the corresponding balance.

The voucher presented by the discount and clearing service provider in respect of a confirmed purchase serves as evidence to the vendor that the transaction originated from the discount and clearing service provider. From the point of view of the discount and clearing service provider, this is valuable since it serves as an incentive to the vendor to sell through the medium of the discount and clearing service provider and justifies the commission that is paid by the vendor to the discount and clearing service provider. However, the method of the invention will still operate even without the voucher being displayed since the balance of the discount is paid to the purchaser upon receipt of proof of purchase by the discount and clearing service provider.

Although the invention has been described by way of example with regard to a single link, in practice two or more links each relating to a different transaction may be embedded in the host web page. In accordance with some embodiments, the links are embedded automatically by search engines such as Google so that suitable “offer for sale” links are presented to the end-user together with content URLs in response to a search by the end-user. In such an embodiment, there is an effective partnership between the discount and clearing service provider and the content host or search engine and the vendor, so that upon completion of a transaction, the discount and clearing service provider pays the web host or search engine possibly by remitting part of the commission it received from the vendor. This increases exposure to both the vendor and the discount and clearing service provider without increasing risk on their part since no fees are payable unless a sale is perfected. In other words, the vendor does not pay for advertising that does not bear fruit. While it is true that the profit to the discount and clearing service provider is reduced by the commission paid to the web host or search engine, the increased volume of sales may be expected to compensate for this reduction.

From the perspective of the web host such as Google, operating at no-risk to the discount and clearing service provider is ostensibly less attractive that known pay-per-click schemes, where a vendor pays Google when a surfer expresses interest in a link (by clicking it) regardless of whether or not a sale is perfected. However, this is more than compensated for by the sheer volume of transactions offered to the host page or search engine by the discount and clearing service provider, who is obviously exposed to many more offers that any given vendor on his own.

In the case where multiple links are embedded in the host web page, the links may be ranked according to one or more of the following properties:
M=estimated profit margin
E=estimated sales volume
P=retail price
D=Discount
C=commission levied by discount and clearing service provider website

For example the links may be ranked according to the following formula:

$$R = \frac{M \cdot E \cdot C \cdot P}{1 - D} ,$$

where

$$M = \frac{{\prod }_{K}}{{\prod }_{G}}$$

where

$${\prod }_{K}$$

is the average profit margin relating to the specific category of goods or services in question; and

$${\prod }_{G}$$

is the average profit margin relating to all sales regardless of their respective categories.

In the case where the purchaser responds to advertisements displayed on a mobile device such as a mobile telephone. PDA or portable computer, geographic location of the purchaser may also be used as a criterion for ranking links presented to the end-user. For example, if the end-user is close to a vendor offering a discounted product or service, the rank may be increased so as to entice the purchaser to buy. Alternatively, a single offer for sale may be presented on behalf of a vendor in close proximity to the end-user as determined, for example, by a GPS unit in the end-user's mobile device.

The landing page stored for each vendor by the discount and clearing service provider may include information received from the vendor relating to payment details e.g. credit card payment details, installments, discount, distribution centers; and details relating to the product or service. This information is used by the discount and clearing service provider to create a suitable offer-for-sale form, which in the on-line embodiment is displayed for allowing the purchaser to confirm interest in the offer.

The web server operated by the discount and clearing service provider is suitably programmed to carry out the invention. To this end, the invention contemplates a computer program being readable by a computer for executing the method of the invention. The invention further contemplates a computer-readable memory tangibly embodying a program of instructions executable by the computer for executing the method of the invention.

What is claimed is:

1. A computer-implemented method of discount retailing a service or product offered by a vendor on-line via a communications network in a host web page in which there is embedded a link to a transaction offering purchase of said service or product, said method comprising:
in response to a purchaser selecting the link, redirecting the purchaser to a landing page relating to said transaction maintained by a discount and clearing service provide website;
using the landing page to confirm interest in the selected service or product;
in response to confirmation of interest by the purchaser, conveying from the discount and clearing service provider website a voucher to the purchaser entitling the purchaser to a partial discount that is provided by the vendor upon actual purchase together with the selected service or product and proof of purchase to the purchaser; and
upon the purchaser presenting the proof of purchase to the discount and clearing service provider, paying a balance of the discount to the purchaser.

2. The method according to claim 1, wherein paying a balance of the discount to the purchaser includes:
the discount and clearing service provider submitting a request to the vendor to receive the balance of the discount; and
on receipt of the balance from the vendor forwarding the balance to the purchaser.

3. The method according to claim 1, wherein the balance of the discount is redeemable within a predetermined time period only.

4. The method according to claim 1, wherein the proof of purchase is presented to the discount and clearing service provider on-line.

5. The method according to claim 4, wherein the discount and clearing service provider maintains an account in respect of each purchaser allowing the purchaser to register said purchase and to provide proof of payment and receipt of the partial discount.

6. The method according to claim 5, wherein the discount and clearing service provider compiles periodic statements for each vendor for charging each vendor a respective cumulative balance on all discounted sales prior to payment by the discount and clearing service provider to each respective purchaser of the corresponding balance.

7. The method according to claim 1, wherein the selected service or product together with the partial discount are transferred to the purchaser off-line in response to the purchaser physically arriving at an off-line store of the vendor.

8. The method according to claim 1, wherein two or more of said links each relating to a different respective transaction are embedded in said web page.

9. The method according to claim 8, wherein the links are ranked according to one or more of the following properties:
M=estimated profit margin;
E=estimated sales volume;
P=retail price;
D=discount; and
C=commission levied by discount and clearing service provider website.

10. The method according to claim 9, wherein the links are ranked according to:
$$R = \frac{M \cdot E \cdot C \cdot P}{1 - D} ,$$
where
$$M = \frac{{\prod }_{K}}{{\prod }_{G}}$$
where
$${\prod }_{K}$$
is the average profit margin relating to the specific category of goods or services in question; and
$${\prod }_{G}$$
is the average profit margin relating to all sales regardless of their respective categories.

11. The method according to claim 1, wherein the landing page includes information received from the vendor relating to:
payments details; and
details relating to the product or service.

12. The method according to claim 11, wherein the payment details include one or more of the following:
credit card payments details;
installments;
discount;
discount; and
distribution centers.

13. A computer readable medium storing computer program code for performing all the steps of claim 1 when said program code is run on a computer.

14. A discount and clearing service provider web server configured to:
conveying a landing page to an end-user computer for receiving confirmation of possible intention to purchase a selected service or product;
in response to confirmation by an interested purchaser, conveying a voucher to the purchaser for presenting to a vendor; and
upon receiving proof of purchase, arraying payment to the purchaser of a balance of discount offered by the vendor.

15. A computer-implemented method of obtaining a discount retailing a service or product offered by a vendor on-line via communication network in a host web page in which there is embedded a link to a transaction offering purchase of said service or product, said method comprising:
expressing interest in an offer of a product or service by selecting said link;
redirecting to a landing page relating to said transaction maintained by a discount and clearing service provider website;
using the landing page to confirm interest in the selected service or product;
in response to confirmation of interest by the purchaser, downloading from the discount and clearing service provider website a voucher entitling the purchaser to a partial discount that is provided by the vendor upon actual purchase together with the selected or product and proof of purchase to the purchaser;
presenting the proof of purchase to the discount and clearing service provider; and
receiving a balance of the discount from the discount and clearing service provider.
